(19) United States
(12) Patent Application Publication
(10) Pub. No.: US 2014/0146237 A1
(43) Pub. Date: May 29, 2014

(54) AUDIO/VIDEO TRANSFORMING SYSTEM AND METHOD FOR TRANSFORMING AUDIO/VIDEO

(71) Applicant: AVERMEDIA TECHNOLOGIES, INC., New Taipei City (TW)

(72) Inventors: Wei-Peng CHIANG, NEW TAIPEI CITY (TW); Chien-Chung CHIANG, TAIPEI HSIEN (TW); Shih-Pei JI, NEW TAIPEI CITY (TW); Po-Wen CHEN, TAIPEI HSIEN (TW)

(73) Assignee: AVERMEDIA TECHNOLOGIES, INC., NEW TAIPEI CITY (TW)

(21) Appl. No.: 13/684,591

(22) Filed: Nov. 26, 2012

(51) Int. Cl. H04N 5/63

(52) U.S. Cl. CPC H04N 5/63
USPC 348/730

(57) ABSTRACT

A method for transferring audio/video includes the steps of determining whether an audio/video transformer is inserted into an audio/video receiving end; controlling a power supply unit to provide electricity for a memory when the audio/video transformer is inserted the audio/video receiving end; controlling a power supply unit to provide electricity for a memory when the audio/video transformer is inserted the audio/video receiving end; controlling the power supply unit to provide electricity for the audio/video transformer for transforming an input signal if the identified information can be identified. Furthermore, a to audio/video transforming system is disclosed herein.

### BACKGROUND

1. Field of Invention

The embodiment of the present invention relates generally to a transferring system and a method for transferring and, more particularly, to an audio/video transforming system and a method for transforming audio/video,

2. Description of Related Art

A High-Definition Multimedia Interface (HDMI) device nowadays can receive signals in the form of HDMI. When users need to use the HDMI device to receive input signals other than that in HDMI, for example, Digital Vision Interface (DVI) and Video Graphics Array (VGA), they need a transformer to transform the input signals into HDMI signal and transfer the HDMI signal to the HDMI device. However, it is inconvenient for the uses in that the transformer requires an external power supply in performing the transformation of the signal form.

Many efforts have been devoted trying to find a solution of the aforementioned problems. Nonetheless, there still a need to improve the existing apparatus and techniques in the art.

### SUMMARY

An audio/video transforming system and a method for transferring audio/video are provided, which addresses the problem of there being a need to use an external power supply when using the transformer.

One aspect of the embodiment of the present invention is to provide a method for transferring audio/video. The method for transferring audio/video comprises the steps of:

determining whether an audio/video transformer is inserted into an audio/video receiving end;

controlling a power supply unit to provide electricity for memory when the audio/video transformer is inserted the audio/video receiving end;

determining whether an identified information stored in the memory can be identified; and

controlling the power supply unit to provide electricity for the audio/video transformer to transform an input signal if the identified information can be identified.

In one embodiment of the present invention, the step of determining whether the audio/video transformer is inserted into the audio/video receiving end comprises:

determining whether a status of a reserved pin of the audio/video receiving end is transformed.

In another embodiment of the present invention, the step of controlling the power supply unit to provide electricity for the memory comprises:

controlling the power supply unit to provide electricity for the memory through a switch; and

outputting a switch signal to the switch for turning on the switch such that the power supply unit provides electricity for the memory through the switch.

In yet another embodiment of the present invention, the audio/video receiving end comprises at least one of a High-Definition Multimedia Interface (HDMI) receiving end, a Digital Vision Interface (DVI) receiving end, and a Video Graphics Array (VGA) receiving end.

In another aspect of the embodiment of the present invention, an audio/video transforming system is provided. The audio/video transforming system comprises an audio/video receiving end and an audio/video transformer. Furthermore, the audio/video receiving end comprises a power supply unit and a micro-controller unit, and the audio/video transformer comprises a memory and a switch. With respect to the structure, the audio/video receiving end is disposed in an electronic device, and the audio/video transformer is pluggablely disposed at the audio/video receiving end. Furthermore, the power supply unit is electrically connected to a power supplier in the electronic device, the micro-controller unit is electrically connected to the power supply unit, and the switch is electrically connected to the memory. With respect to the operation, the memory is operable to store identified information. When the audio/video transformer is inserted into the audio/video receiving end, the micro-controller unit receives a detecting signal and controls the power supply unit to provide electricity to the memory through the switch; the micro-controller unit determines whether the identified information stored in the memory can be identified and controls the power supply unit to provide electricity for the audio/video transformer when the identified information stored in the memory can be identified.

In one embodiment of the present invention, the audio/video receiving end further comprises a detecting unit. The detecting unit is operable to detect whether the audio/video transformer is inserted into the audio/video receiving end, wherein the detecting unit outputs the detecting signal when the detecting unit detects that the audio/video transformer is inserted into the audio/video receiving end.

In another embodiment of the present invention, the audio/video receiving end further comprises a reserved pin. A status of the reserved pin is transformed such that the detecting signal is outputted when the audio/video transformer is inserted into the audio/video receiving end.

In yet another embodiment of the present invention, the audio/video transformer further comprises an audio/video transforming unit. The audio/video transforming unit is operable to transform an input signal when the power supply unit provides electricity for the audio/video transformer.

In still another embodiment of the present invention, the micro-controller unit receives the detecting signal and outputs a switch signal to the switch for turning on the switch such that the power supply unit provides electricity to the memory through the switch when the audio/video transformer is inserted into the audio/video receiving end.

In yet another embodiment of the present invention, the audio/video receiving end comprises at least one of a High-Definition Multimedia Interface (HDMI) receiving end, a Digital Vision Interface (DVI) receiving end, and a Video Graphics Array (VGA) receiving end.

As a result, the embodiments of the present invention provide an audio/video transforming system and a method for transferring audio/video, which address the problem of there being a need to use an external power supply when using the transformer.

In addition, with the use of a dual-determination, the audio/video transforming system and the method for transferring audio/video can make sure that the audio/video transformer is the device of the audio/video transforming system of the embodiment of the present invention or the device which the method for transferring audio/video of the embodiment of the present invention want to control.

### BRIEF DESCRIPTION OF THE DRAWINGS

The invention can be more fully understood by reading the following detailed description of the embodiments, with reference made to the accompanying drawings as follows:

FIG. 1 schematically shows a block diagram of an audio/video transforming system according to embodiments of the present invention.

FIG. 2 schematically shows a circuit diagram of the audio/video transforming system of FIG. 1 according to embodiments of the present invention.

FIG. 3 schematically shows a flow diagram of a method for transforming audio/video according to embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

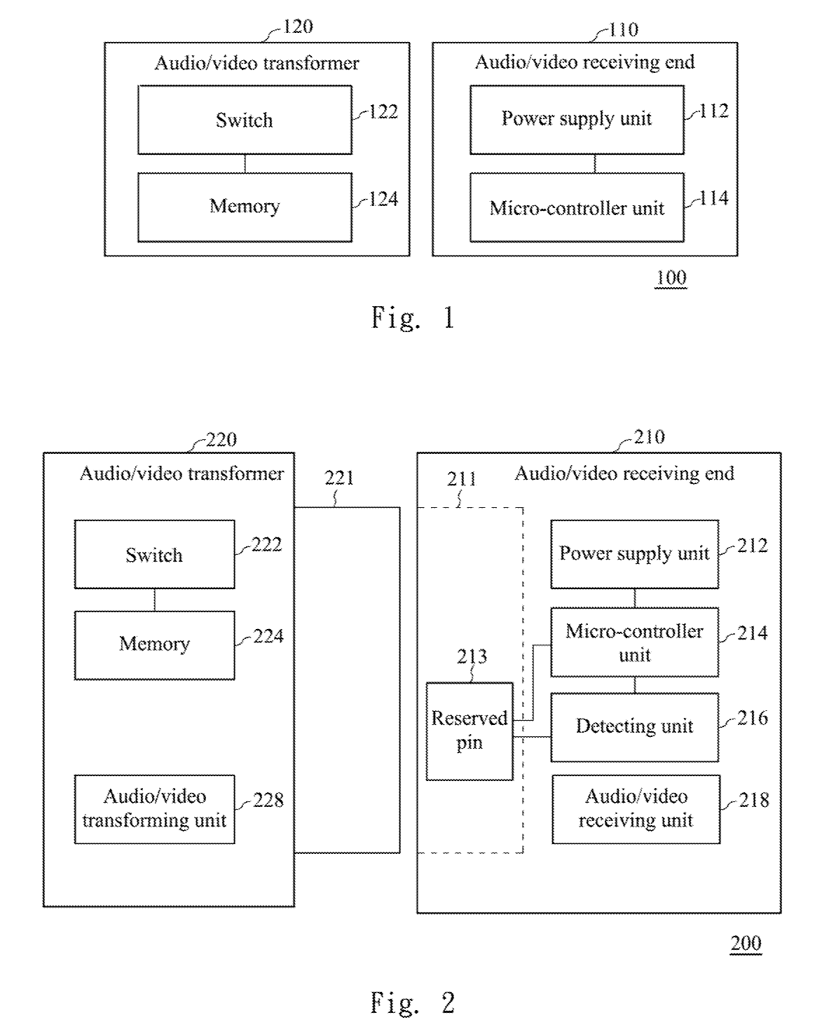

FIG. 1 schematically shows a block diagram of an audio/video transforming system according to embodiments of the present invention. As shown in the Figure, the audio/video transforming system 100 comprises an audio/video receiving end 110 and an audio/video transformer 120. Furthermore, the audio/video receiving end 110 comprises a power supply unit 112 and a micro-controller unit 114, and the audio/video transformer 120 comprises a switch 122 and a memory 124.

With respect to the structure, the audio/video receiving end 110 is disposed in an electronic device, and the audio/video transformer 120 is pluggablely disposed at the audio/video receiving end 110. Furthermore, the power supply unit 112 is electrically connected to the power supplier in the electronic device. The micro-controller unit 114 is electrically connected to the power supply unit 112, and the switch 122 is electrically connected to the memory 124.

When implementing the embodiment of the present invention, the audio/video receiving end can be a High-Definition Multimedia Interface (HDMI) receiving end, a Digital Vision Interface (DVI) receiving end, or a Video Graphics Array (VGA) receiving end, and the electronic device can be a device which needs HDMI, DVI, or VGA as its input. However, the scope of the present invention is not intended to be limited to the above-mentioned embodiment. Moreover, the memory 124 can be, but not limited to an Electrically-Erasable Programmable Read-Only Memory (EEPROM).

With respect to the operation, the memory 124 is operable to store identified information. When the audio/video transformer 120 is inserted into the audio/video receiving end 110, the micro-controller unit 114 receives a detecting signal and controls the power supply unit 112 to provide electricity for the memory 124 through the switch 122; subsequently, the micro-controller unit 114 determines whether the identified information stored in the memory 124 can be identified and controls the power supply unit 112 to provide electricity for the audio/video transformer 120 when the identified information stored in the memory can be identified.

In detailed, the identified information can be, but not limited to Plug and Play Identification (PNPID). The identified information which is corresponding to the audio/video receiving end 110 is disposed in the memory 124 of the audio/video transformer 120. When the audio/video transformer 120 is inserted into the audio/video receiving end 110, the micro-controller unit 114 determines whether the identified information stored in the memory 124 is the identified information which is corresponding to the audio/video receiving end 110. In other words, the micro-controller unit 114 is operable to determine whether the identified information stored in the memory 124 can be identified to make sure that the audio/video transformer 120 is one device of the audio/video transforming system 100 of the present invention.

With the use of a dual-determination of the embodiment of h present invention as following:

determining whether the audio/video transformer 120 is inserted into the audio/video receiving end 110 and

determining whether the identified information in the audio/video transformer 120 can be identified,

the audio/video transformer 120 can be confirmed as a device of the audio/video transforming system 100 of the present invention. The audio/video receiving end 110 provides power to the audio/video transformer 120 for improving the problem of there being a need to use an external power supply when using the transformer.

FIG. 2 schematically shows a circuit diagram of the audio/video transforming system of FIG. 1 according to embodiments of the present invention. As shown in the Figure, the audio/video receiving end 210 further comprises a reserved pin 213. When the audio/video transformer 220 is inserted into the audio/video receiving end 210, a status of the reserved pin 213 is transformed such that the detecting signal is outputted to the micro-controller unit 214, meanwhile, the micro-controller unit 214 confirms that the audio/video transformer 220 is inserted into the audio/video receiving end 210.

When implementing the embodiment of the present invention, the audio/video transformer 220 can comprise an audio/video transformer male part 221, and the audio/video receiving end 210 can comprise an audio/video receiving end female part 211. The audio/video transformer male part 221 and the audio/video receiving end female part 211 is corresponding to each other, and the audio/video transformer male part 221 can be inserted into the audio/video receiving end female part 211. At this time, the status of the reserved pin 213 is transformed. The reserved pin 213 can be an unoccupied pin, and the transformation of the status can be, but not limited to transform from high level voltage into low level voltage.

In one embodiment of the present invention, the audio/video receiving end 210 further comprises a detecting unit 216. The detecting unit 216 is operable to detect whether the audio/video transformer 220 is inserted into the audio/video receiving end 210. When the audio/video transformer 220 is inserted into the audio/video receiving end 210, the detecting unit 216 outputs the detecting signal for the micro-controller unit 214. Meanwhile, the micro-controller unit 214 confirms that the audio/video transformer 220 is inserted into the audio/video receiving end 210. When implementing the embodiment of the present invention, the detecting unit 216 can be used to execute a detection process directly or is electrically connected to the reserved pin 213 to detect the transformation of the status of the reserved pin 213, so the scope of the invention is not intended to be limited to the embodiment as shown in FIG. 2.

In another embodiment of the present invention, the audio/video transformer 220 further comprises an audio/video transforming unit 228. When the power supply unit 212 provides electricity to the audio/video transformer 220; that is to say, the audio/video transformer 120 is confirmed as a device of the audio/video transforming system 100 of the embodiment of the present invention and is inserted into the audio/video receiving end 210, the audio/video transforming unit is operable to transform the input signal and transfer to an audio/video receiving unit 218.

In another embodiment of the present invention, when the audio/video transformer 220 is inserted into the audio/video receiving end 210, the micro-controller unit 214 receives the detecting signal and outputs the switch signal to the switch 222 for turning on the switch 222 such that the power supply unit 212 provides electricity to the memory 224 through the switch 222. The steps as mentioned above is a preprocess of the step of determining whether the identified information stored in the memory can be identified. When the audio/video transformer 220 is inserted into the audio/video receiving end 210, the power supply unit 212 provides electricity to the memory 224 only by the switch 222 but not by the whole audio/video transformer 220, accordingly, the memory 224 can be read successfully. After confirming that the identified information stored in the memory can be identified, the power supply unit 212 provides electricity to the whole audio/video transformer 220.

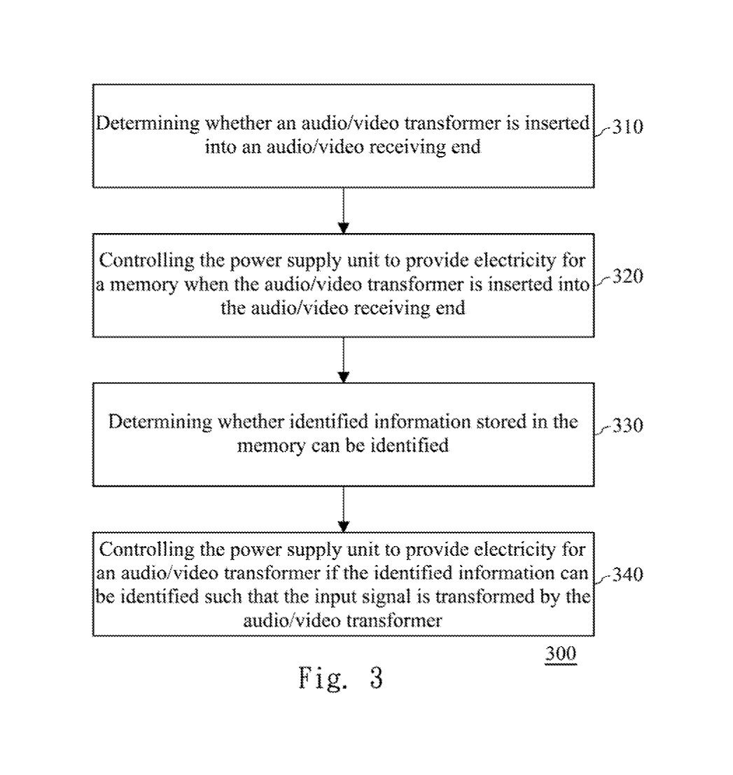

FIG. 3 schematically shows a flow diagram of a method for transforming audio/video according to embodiments of the present invention. As shown in the Figure, the method for transferring audio/video 300 comprises the steps of:

step 310: determining whether an audio/video transformer is inserted into an audio/video receiving end,

step 320: controlling the power supply unit to provide electricity for a memory when the audio/video transformer is inserted into the audio/video receiving end,

step 330: determining whether identified information stored in the memory can be identified,

step 340: controlling the power supply unit to provide electricity for an audio/video transformer if the identified information can be identified such that the input signal is transformed by the audio/video transformer.

To make the method for transferring audio/video 300 of the embodiment of the present invention easier to be understood, the method 300 for transferring the audio/video thereof described exemplarily in accordance with FIGS. 2 and 3. In step 310, when the audio/video transformer 220 is inserted into the audio/video receiving end 210, the detecting signal is outputted to the micro-controller unit 214 due to the status of the reserved pin 213 being transformed. At present, the control unit 214 confirms that the audio/video transformer 220 is inserted into the audio/video receiving end 210. In another embodiment of the present invention, the detecting unit 216 is operable to determine whether the audio/video transformer 220 is inserted into the audio/video receiving end 210. When the audio/video transformer 220 is inserted into the audio/video receiving end 210, the detecting signal is outputted from the detecting unit 216 to the micro-controller unit 214, meanwhile, the control unit 214 confirms that the audio/video transformer 220 is inserted into the audio/video receiving end 210.

In step 320, the controller 114 can be used to control the power supply unit 112 to provide electricity for the memory 124 when the audio/video transformer 220 is inserted into the audio/video receiving end 210. Referring to step 330, the micro-controller unit 114 is used to determine whether the identified information stored in the memory 124 can be identified.

In detailed, the identified information can be, but not limited to PNPID. The identified information which is corresponding to the audio/video receiving end 110 is disposed in the memory 124 of the audio/video transformer 120. When the audio/video transformer 120 is inserted into the audio/video receiving end 110, the micro-controller unit 114 determines whether the identified information stored in the memory 124 is the identified information which is corresponding to the audio/video receiving end 110. In other words, the micro-controller unit 114 is operable to determine whether the identified information stored in the memory 124 can be identified to make sure that the audio/video transformer 120 is one device which the method for transforming audio/video 300 of the present invention wants to control.

With the use of a dual-determination of the embodiment of the present invention as following:

the audio/video transformer 120 can be confirmed as a device which the method for transforming audio/video 300 of the present invention wants to control. The audio/video receiving end 110 provides power to the audio/video transformer 120 for improving the problem of there being a need to use an external power supply when using the transformer.

In one embodiment of the present invention, the step of determining whether the audio/video transformer is inserted into the audio/video receiving end comprises:

determining whether a status of a reserved pin of the audio/video receiving end is transformed. In this step, when the audio/video transformer 220 is inserted into the audio/video receiving end 210, the detecting signal is outputted to the micro-controller unit 214 due to the status of the reserved pin 213 being transformed. At present, the control unit 214 confirms that the audio/video transformer 220 is inserted into the audio/video receiving end 210.

In another embodiment of the present invention, the step of controlling the power supply unit to provide electricity for the memory comprises:

controlling the power supply unit to provide electricity for the memory through a switch; and

outputting a switch signal to the switch for turning on the switch such that the power supply unit provides electricity for the memory through the switch. In this step, when the audio/video transformer 220 is inserted into the audio/video receiving end 210, the micro-controller unit 214 can be used to output the switch signal to the switch 222 for turning on the switch 222 such that the power supply unit 212 provides electricity to the memory 224 through the switch 222. The steps as mentioned above is a preprocess of the step of determining whether the identified information stored in the memory can be identified. When the audio/video transformer 220 is inserted into the audio/video receiving end 210, the power supply unit 212 provides electricity to the memory 224 only by the switch 222 but not by the whole audio/video transformer 220, accordingly, the memory 224 can be read successfully. After confirming that the identified information stored in the memory can be identified, the power supply unit 212 provides electricity to the whole audio/video transformer 220.

In still another embodiment of the present invention, the audio/video receiving end comprise at least one of a HDMI receiving end, a DVI receiving end, and a VGA receiving end. However, the scope of the present invention is not intended to be limited to the above-mentioned embodiment. Moreover, the memory 124 can be, but not limited to an EEPROM.

Those having skill in the art will appreciate that the method for transferring audio/video 300 can be performed with software, hardware and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of method for transferring audio/video 300 named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

in view of the foregoing embodiments of the present invention, many advantages of the present invention are now apparent. The embodiment of the present invention provides an audio/video transforming system and a method for transferring audio/video, which address the problem of there being a need to use an external power supply when using the transformer.

In addition, with the use of a dual-determination, the audio/video transforming system and the method for transferring audio/video can make sure that the audio/video transformer is the device of the audio/video transforming system of the embodiment of the present invention or the device which the method for transferring audio/video of the embodiment of the present invention want to control.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A method for transferring audio/video, comprising the steps of:
determining whether an audio/video transformer is inserted into an audio/video receiving end;
controlling a power supply unit to provide electricity for a memory when the audio/video transformer is inserted the audio/video receiving end;
determining whether an identified information stored in the memory can be identified; and
controlling the power supply unit to provide electricity for the audio/video transformer to transform an input signal if the identified information can be identified.

2. The method for transferring audio/video according to claim 1, wherein the step of determining whether the audio/video transformer is inserted into the audio/video receiving end comprises:
determining whether a status of a reserved pin of the audio/video receiving end is transformed.

3. The method for transferring audio/video according to claim 1, wherein the step of controlling the power supply unit to provide electricity for the memory comprises:
controlling the power supply unit to provide electricity for the memory through a switch; and
outputting a switch signal to the switch for turning on the switch such that the power supply unit provides electricity for the memory through the switch.

4. The method for transferring audio/video according to claim 1, wherein the audio/video receiving end comprises at least one of a High-Definition Multimedia Interface (HDMI) receiving end, a Digital Vision Interface (DVI) receiving end, and a Video Graphics Array (VGA) receiving end,

5. A audio/video transforming system, comprising:
an audio/video receiving end disposed in an electronic device comprising:
a power supply unit electrically connected to a power supplier in the electronic device;
a micro-controller unit electrically connected to the power supply unit; and
an audio/video transformer pluggablely disposed at the audio/video receiving end comprising:
a memory being operable to store an identified information; and
a switch electrically connected to the memory and being operable to receive electricity provided by the power supply unit,
wherein, when the audio/video transformer is inserted into the audio/video receiving end, the micro-controller unit receives a detecting signal and controls the power supply unit to provide electricity to the memory through the switch; the micro-controller unit determines whether the identified information stored in the memory can be identified and controls the power supply unit to provide electricity for the audio/video transformer when the identified information stored in the memory can be identified.

6. The audio/video transforming system according to claim 5, wherein the audio/video receiving end further comprises:
a detecting unit being operable to detect whether the audio/video transformer is inserted into the audio/video receiving end, wherein the detecting unit outputs the detecting signal when the detecting unit detects that the audio/video transformer is inserted into the audio/video receiving end.

7. The audio/video transforming system according to claim 5, wherein the audio/video receiving end further comprises:
a reserved pin, wherein a status of the reserved pin is transformed such that the detecting signal is outputted when the audio/video transformer is inserted into the audio/video receiving end.

8. The audio/video transforming system according to claim 5, wherein the audio/video transformer further comprises.
an audio/video transforming unit, wherein the audio/video transforming unit is operable to transform n input signal when the power supply unit provides electricity for the audio/video transformer.

9. The audio/video transforming system according to claim 5, wherein the micro-controller unit receives the detecting signal and outputs a switch signal to the switch for turning on the switch such that the power supply unit provides electricity to the memory through the switch when the audio/video transformer is inserted into the audio/video receiving end.

10. The audio/video transforming system according to claim 5, wherein the audio/video receiving end comprises at least one of a High-Definition Multimedia Interface (HDMI) receiving end, a Digital Vision Interface (DVI) receiving end, and a Video Graphics Array (VGA) receiving end.
